(19) United States
(12) Patent Application Publication
(10) Pub. No.: US 2026/0031863 A1
(43) Pub. Date: Jan. 29, 2026

(54) APPARATUS AND METHODS FOR PHASE DETERMINATION IN MULTI-BEAM COMMUNICATION SYSTEMS

(71) Applicant: QUALCOMM Incorporated, San Diego, CA (US)

(72) Inventors: Alexandros MANOLAKOS, Athens (GR); Mukesh KUMAR, Hyderabad (IN)

(21) Appl. No.: 19/099,748

(22) PCT Filed: Jul. 28, 2023
(86) PCT No.: PCT/US2023/071220

§ 371 Date: Jan. 29, 2025

(30) Foreign Application Priority Data
Sep. 22, 2022 (GR) 20220100776

(51) Int. Cl. H04B 7/0408; G01S 5/02; H04B 7/06

(52) U.S. Cl. CPC H04B 7/0408; G01S 5/0236; H04B 7/0617; H04B 7/0695

(57) ABSTRACT

Methods, systems, and apparatuses to detect and provide coherent carrier phase measurements in multi-beam wireless communication systems. For example, a computing device may receive a plurality of beam phase measurements for a plurality of signals transmitted using corresponding beams. The plurality of beam phase measurements may have been determined by a plurality of user equipments (UEs) receiving the plurality of signals. The computing device may also determine phase associations between the beams based on the plurality of beam phase measurements. Further, the computing device may generate assistance data based on the phase associations, and may transmit the associate data.

### CROSS-REFERENCE TO RELATED APPLICATIONS

This application for Patent is a 371 of international Patent Application PCT/US2023/071220, filed Jul. 28, 2023, which claims priority to Greek Patent Application 20220100776, filed Sep. 22, 2022, all of which are hereby incorporated by referenced in their entirety and for all purposes.

### BACKGROUND

### Field of the Disclosure

This disclosure relates generally to wireless communication systems and, more specifically, to coherent carrier phase determination in multi-beam wireless communication systems.

### Description of Related Art

Wireless communication systems can provide various telecommunications services including, for example, audio, video, data, messaging, and network access. For instance, wireless communication systems may allow for communications among various devices, such as Internet of Things (IoT) devices. These wireless communication systems can be based on various technologies, such as code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TDSCDMA) systems, Long Term Evolution (LTE) systems, WiMax systems, and Evolved High Speed Packet Access (HSPA+) systems. Further, in some instances, an operation of these wireless communication systems may conform to a standard, such as the third generation (3G) of broadband cellular network technology, the fourth generation (4G) of broadband cellular network technology, and more recently the fifth generation (5G) of broadband cellular network technology (also known as New Radio (NR)).

A wireless communication system may include a number of base stations (BSs) that allow communication for a number of user equipment (UE). For example, a UE may receive data from a BS in a downlink, and may transmit data to a BS in an uplink. The data exchanged during uplinks and downlinks may be transmitted using a carrier operating within a frequency spectrum. A receiving device, such as a BS receiving an uplink or a UE receiving a downlink, receives the uplink or downlink at a phase of the carrier. The wireless communication system may also provide location services, and in some instances, the wireless communication system may include a location management function (LMF) that can provide location services to UEs.

### SUMMARY

According to one aspect, a method includes obtaining a first phase value for a first beam. The method also includes obtaining a second phase value for a second beam. Further, the method includes generating phase association data characterizing a phase association between the first beam and the second beam based on the first phase value and the second phase value. The method also includes transmitting assistance data comprising the phase association data across a radio access network.

According to another aspect, an apparatus comprises a non-transitory, machine-readable storage medium storing instructions, and at least one processor coupled to the non-transitory, machine-readable storage medium. The at least one processor is configured to execute the instructions to obtain a first phase value for a first beam. The at least one processor is also configured to execute the instructions to obtain a second phase value for a second beam. Further, the at least one processor is configured to execute the instructions to generate phase association data characterizing a phase association between the first beam and the second beam based on the first phase value and the second phase value. The at least one processor is configured to execute the instructions to transmit assistance data comprising the phase association data across a radio access network.

According to another aspect, a non-transitory, machine-readable storage medium stores instructions that, when executed by at least one processor, causes the at least one processor to perform operations that include obtaining a first phase value for a first beam. The operations also include obtaining a second phase value for a second beam. Further, the operations include generating phase association data characterizing a phase association between the first beam and the second beam based on the first phase value and the second phase value. The operations also include transmitting assistance data comprising the phase association data across a radio access network.

According to another aspect, an apparatus includes a means for obtaining a first phase value for a first beam. The apparatus also includes a means for obtaining a second phase value for a second beam. Further, the apparatus includes a means for generating phase association data characterizing a phase association between the first beam and the second beam based on the first phase value and the second phase value. The apparatus also includes a means for transmitting assistance data comprising the phase association data across a radio access network.

### BRIEF DESCRIPTION OF DRAWINGS

FIG. 1 is a block diagram of an exemplary wireless communication system, according to some implementations;

FIG. 2 is a block diagram of an exemplary network device, according to some implementations;

FIGS. 3A, 3B, 3C, and 3D illustrate exemplary communications among networked devices, according to some implementations;

FIGS. 4A, 4B, 4C, 5A, and 5B illustrate the receiving of beams, according to some implementations;

FIGS. 6 and 7 are flowcharts of exemplary processes for generating assistance data with phase association, according to some implementations; and

FIG. 8 illustrates a transmission beam within a coordinate plane, according to some implantations.

### DETAILED DESCRIPTION

While the features, methods, devices, and systems described herein may be embodied in various forms, some exemplary and non-limiting embodiments are shown in the drawings, and are described below. Some of the components described in this disclosure are optional, and some implementations may include additional, different, or fewer components from those expressly described in this disclosure.

Base stations (BSs), which may also be referred to as a Node B, a gNB, a transmit receive point (TRP), an access point (AP), and the like, when operating in a wireless communication system such as New Radio (NR), may transmit positioning reference signals (PRSs) that user equipments (UEs) may detect to determine their location. For instance, NR may support one or more UE assisted or UE based positioning methods, such as multi-cell round trip time (multi-RTT) positioning, downlink time difference of arrival (DL-TDOA) positioning, and downlink angle of departure (DL-AoD) positioning methods. To determine its position, a UE may receive assistance data, such as from a location management function (LMF), that identifies downlink PRS (DL-PRS) resources.

For instance, the download PRS may include up to four frequency layers, where each frequency layer may identify up to sixty-four TRPs. Further, for each TRP, DL-PRS may identify two PRS resource sets, where each PRS resource set may include up to sixty-four PRS resources. In some examples, an LMF may generate the assistance data such that the up to four frequency layers are in order of priority (e.g., a decreasing order of measurement priority, such as where the first frequency layer in the assistance data has highest priority, and the last frequency layer in the assistance data has least priority), the up to sixty-four TRPs for each frequency layer are in order of priority, the two PRS resource sets for each TRP are in order of priority, and the sixty-four resources of each PRS resource set are in order of priority.

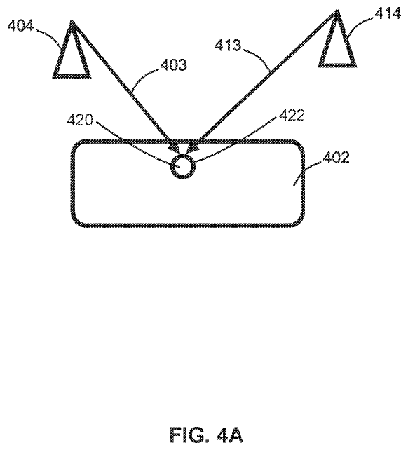

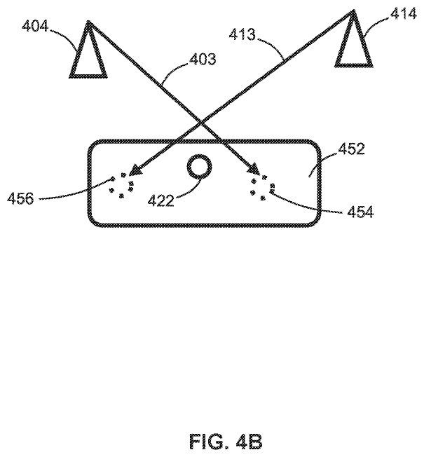

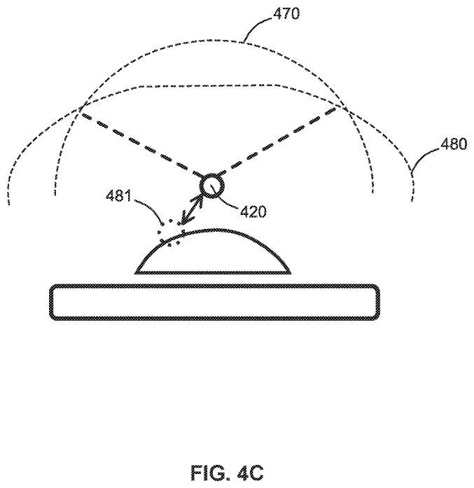

When a signal is transmitted, such as a PRS from a BS to a UE, the signal is transmitted within a beam, and the beam is received (e.g., by the UE) with a particular beam phase. The beam phase at which a beam is received, however, may not correspond to the beam phase expected. For instance, FIG. 4A illustrates an idealized example in which an antenna panel 402 (e.g., an antenna of a UE) may receive a first signal 403 transmitted by a first base station 404 using a first beam. Similarly, the antenna panel 402 may receive a second signal 413 transmitted by a second base station 414 using a second beam. In some instances, each of the first signal 403 and the second signal 413 may be received with a phase center 420 that collocates with a mean phase center 422 of the first signal 403 and the second signal 413. The phase center 420 may indicate an apparent direction of radiation. For instance, and as illustrated in FIG. 4C, the phase center 420 may have an ideal equiphase contour 470 that is, at each point, equidistant from the phase center 420 (e.g., a spherical equiphase contour).

In contrast to the idealized example of FIG. 4A, real antennas often exhibit irregular equiphase contours. For instance, as further illustrated in FIG. 4C, a real antenna may have a real equiphase contour 480 that is not equidistant from the phase center 420. Instead, the real antenna may have a phase center 481, offset from the phase center 420. As a result, beams that are otherwise transmitted with a same initial phase may nonetheless be received by a device with differing phases. An initial phase may be the phase of a beam when the transmission begins. As an example, and with reference to FIG. 4B, antenna panel 452 may receive the first signal 403 transmitted by the first base station 404 with a first phase center 454, and may receive the second signal 413 transmitted by the second base station 414 with a second phase center 456. In this example, neither of the first phase center 454 and second phase center 456 are collocated with the mean phase center 422. As such, PRSs received from different TRPs, even when transmitted with beams having a same initial phase, may have differing phase centers causing phase errors. Other reasons for phase errors may include, for example, phase noise, beam frequency offset (e.g., Doppler effect), oscillator drift, antenna reference point location errors, initial phase errors, and phase center offset errors.

In some implementations, a plurality of BSs (e.g., TRPs) may employ crowdsourcing to receive and aggregate beam phase measurements for a plurality of beams. For instance, the plurality of BSs may transmit one or more beams, with each beam operating within a corresponding frequency spectrum. UEs may detect one or more of these beams (e.g., from a same BS, or from differing BSs), and determine a beam phase for each detected beam. The UEs may then transmit the beam phase measurements to the corresponding BSs. The UEs may also transmit, to the BSs, location data identifying their location. The location data may identify a distance from the transmitting BS. For instance, the location data may include latitude, longitude, and, in some instances, an altitude value. The BSs may aggregate the received beam phase measurements and, in some instances, the location data, within one or more data repositories, such as cloud-based servers. In some instances, the aggregated data may include beam phase measurements captured by other devices, such as PRUs. In addition, in some examples the UEs may further transmit reference time data indicating a time at which the beam phase measurements were taken. In some examples, the BSs determine a time the beam phase measurements are received, and stores the determined times along with the beam phase measurements within the one or more data repositories.

A networked device, such as an LMF, may obtain the aggregated measurements and location data from the data repositories, or from the BSs. In some examples, the LMF receives beam phase measurements and location data directly from UEs. The LMF may determine beams (e.g., beams) with a same initial phase based on the aggregated measurements. For instance, the LMF may determine, for a geographical area, beams with the same initial phase. The geographical area may be an area defined by a range of latitude, longitude, and, in some examples, altitude values. The LMF may determine, based on the location data, beam phase measurements for beams that were reported by UEs from within the geographical area. Further, the LMF may determine beams with a same initial phase based on the beam phase measurements corresponding to the geographical area.

Further, the LMF may generate beam phase data that identifies which beams have a same initial phase, may package the beam phase data within assistance data, and may transmit the assistance data across a radio access network, such as a 5G radio access network. Network devices, such as UEs, may receive the assistance data. For instance, the beam phase data may identify a first set of beams of a BS that have a same initial phase, a second set of beams of the BS that have a same initial phase, and a third set of beams of the BS that have a same initial phase. In some examples, the LMF considers phases of beams that are within a range to have a same initial phase, and may generate assistance data identifying the beams as such. For example, the LMF may consider beams with initial phases within 10 degrees of each other to have the same initial phase.

In some examples, the LMF generates beam phase data that identifies, for each of a plurality of angles (e.g., azimuth angles), a set of beams of a BS that have a same initial phase within a geographical region. The angles may be measured with respect to a centerline of each BS transmission. For instance, the beam phase data may identify a first set of beams of a BS that have a same initial phase at an azimuth angle of 0 degrees, a second set of beams of the BS that have a same initial phase at an azimuth angle of 10 degrees, and a third set of beams of the BS that have a same initial phase at an azimuth angle of 20 degrees. In some examples, the LMF generates beam phase data that identifies, for each of a plurality of azimuth angles at each of a plurality of elevation angles, a set of beams of a BS that have a same initial phase.

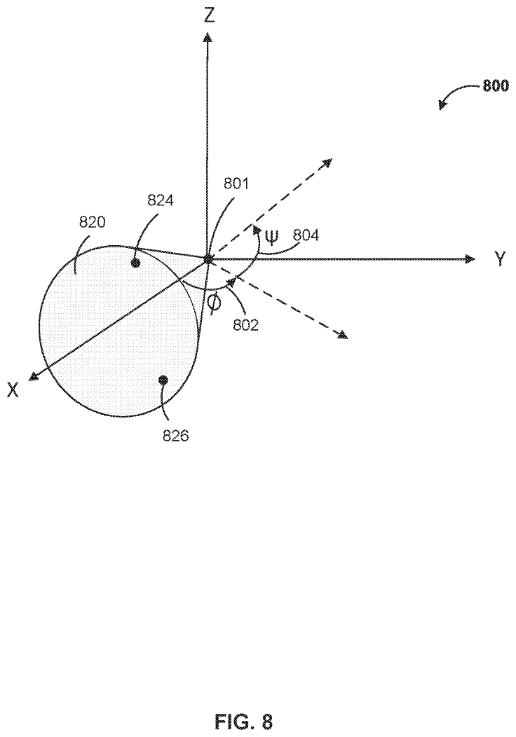

For instance, FIG. 8 illustrates a coordinate plane 800 that identifies each of an x-axis, y-axis, and a z-axis. The x-axis may correspond to a centerline of a beam 820 transmitted by a BS 801. An azimuth angle may be measured from the x-axis along the x-y coordinate plane, as indicated by first angle 802. An elevation angle may be measured from the x-y coordinate plane in the z-axis direction, as indicated by second angle 804. Thus, for example, first UE location 824 may be at an azimuth angle of 15 degrees, and an elevation angle of 40 degrees, while second UE location 826 may be at an azimuth angle of 10 degrees, and an elevation angle of zero degrees (i.e., along the x-y coordinate plane). The LMF may generate beam phase data that identifies a first set of BS beams with a same beam phase at first UE location 824 (i.e., at the azimuth angle of fifteen degrees, and the elevation angle of 40 degrees), and a second set of BS beams with a same beam phase at second UE location 826 (i.e., at the azimuth angle of ten degrees, and the elevation angle of zero degrees).

In some examples, the LMF may generate beam phase data that, alternatively or additionally, identifies which beams have a same drift of initial phase. For example, the LMF may generate beam phase data that identifies, for each of a plurality of azimuth angles at each of a plurality of elevation angles, a set of beams of a BS that have a same initial phase, and a same drift of the initial phase.

Among other advantages, the embodiments described herein may allow networked devices, such as UEs, to determine beams with similar beam phases. The UEs may, for example, prioritize resources based on the beams identified as having similar beam phases. In some instances, the UEs may minimize phase errors by prioritizing resources of beams with a similar beam phase over resources of beams with a different beam phase based on the UE's location.

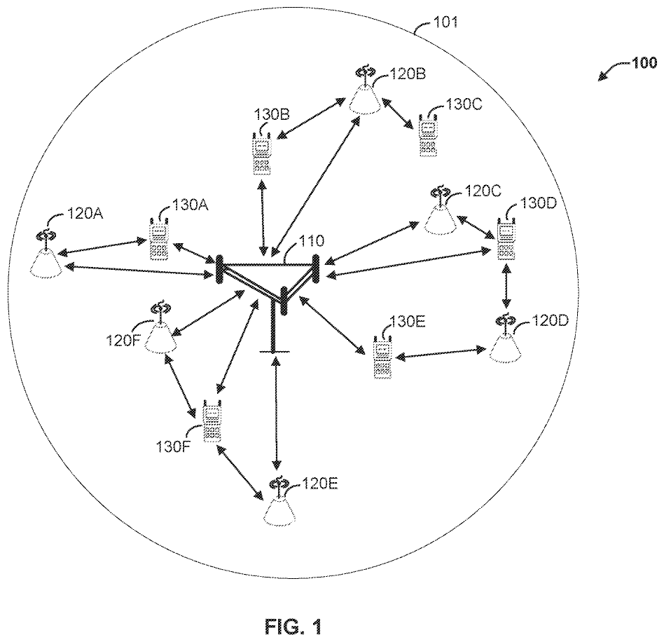

FIG. 1 is a block diagram of at least portions of an exemplary wireless communication system 100, such as a 5G wireless communication system. Wireless communication system 100 includes at least one BS 110 (e.g., a TRP, a gNB), a plurality of UEs 130, and a plurality of LMFs 120. Although wireless communication system 100 may include additional components, such as access and mobility management functions (AMFs), session management functions (SMF), relay stations, and any other suitable components, they are not illustrated for purposes of simplicity.

Each UE may be, for example, a computer (e.g., personal computer, a desktop computer, or a laptop computer), a mobile device such as a tablet computer, a wireless communication device (such as, e.g., a mobile telephone, a cellular telephone, a satellite telephone, and/or a mobile telephone handset), an Internet telephone, a digital camera, a digital video recorder, a handheld device, such as a portable video game device or a personal digital assistant (PDA), a drone device, a virtual reality device (e.g., a virtual reality headset), an augmented reality device (e.g., augmented reality glasses), or any other suitable device. BS 110 may provide communication coverage for a particular geographical area, such as geographical area 101. For example, geographical area 101 may correspond to a macro cell, a pico cell, a femto cell, or any other type of cell. To provide coverage, BS 110 may transmit one or more beams that cover at least portions of geographical area 101. Each beam may operate within a frequency spectrum. For example, BS 110 may transmit data, such as PRS, within downlinks of the one or more beams to UEs 130.

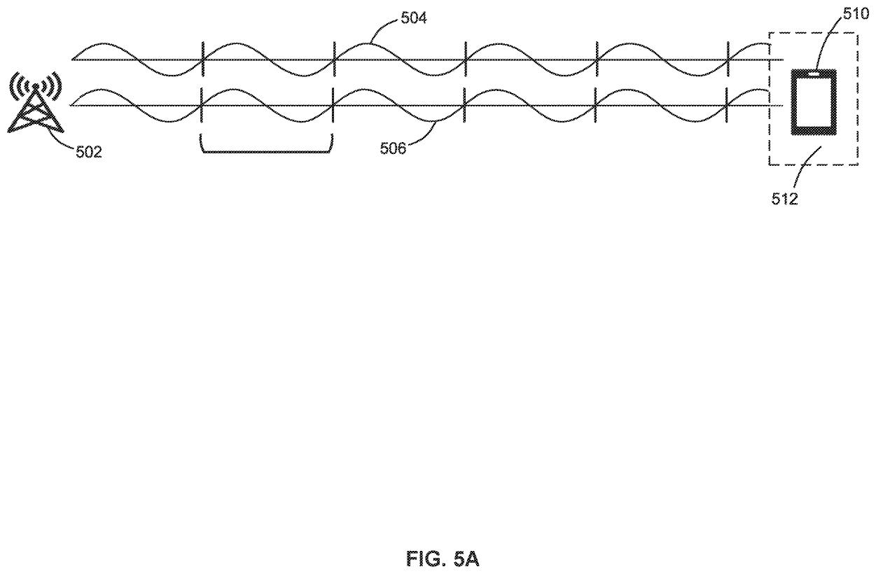

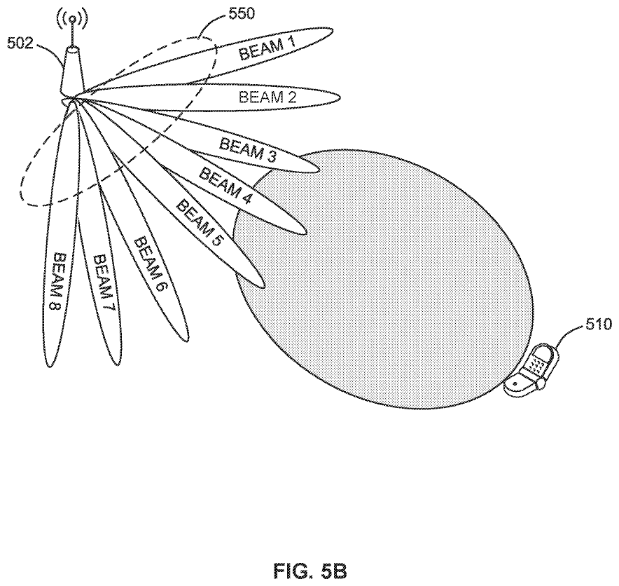

As described herein, UEs 130 may detect and measure initial beam phases of beams received from BS 110. For example, FIG. 5A illustrates a TRP 502 transmitting a first beam 504 and a second beam 506, which are received by a UE 510 at a location 512. Each of the first beam 504 and the second beam 506 may include, for example, a PRS. The UE 510 can measure the beam phase of each of the first beam 504 and second beam 506 as received. The beam phase may be a fraction of a wavelength of each respective beam (e.g., a value in the range of 0 to a wavelength, inclusive). Further, the beam phase measured for the first beam 504 may differ from the beam phase measured for the second beam 506. UE 510 may transmit the beam phase measurements, and in some examples, location data identifying location 512 (e.g., latitude, longitude, and elevation values), and reference time data indicating a time that the beam phase measurements were captured, to TRP 502. TRP 502 may receive the beam phase measurements, and, in some examples, the location data and the reference time data, and store the beam phase measurements and, in some examples, the location data and the reference time data, within one or more data repositories.

FIG. 5B illustrates TRP 502 perform a “beam sweep” of eight beams 550, where each beam includes a transmission of a beam that includes a PRS. Further, and based on UE's 510 reception area 560 (e.g., UE's receive beam), only beams 3, 4, and 5 are received as line of sight (LOS) beams. Although the distance between TRP 502 and UE 510 remains the same, the UE 510 may nonetheless detect varying beam phase measurements for each of beams 3, 4, and 5. For instance, the initial transmit phase for each beam may not be the same, resulting in the UE 510 measuring varying initial beam phase measurements for the beams. UE 510 may transmit the initial beam phase measurements for each beam to TRP 502.

Referring back to FIG. 1, BS 110 may also communicate with LMFs 120. For example, LMFs 120 may request and receive information, such as DL-PRS configurations, from each BS 110. Further, LMFs 120 can provide support location services to connected UEs 130. As illustrated, UE 130a is in communication with LMF 120A over a radio access network, and thus LMF 120A can provide location services to UE 130a. Similarly, UEs 130b and 130c are in communication with LMF 120b over a radio access network, and thus LMF 120b can provide location services to UEs 130b, 130c. UE 130d is in communication with each of LMF 120c and LMF 120d, and can receive location services from LMFs 120c, 120d. UE 130e is in communication with, and can receive location services from, LMF 120d. Further, UE 130f is in communication with each of LMF 120e and LMF 120f, and thus can receive location services from LMFs 120e, 120f.

To provide location services, LMFs 120 may receive measurement information from any connected UEs 130. Based on the operating mode (e.g., either UE-based or UE-assisted modes), the measurement information may include, for example, one or more of location information (e.g., latitude, longitude, and altitude data), velocity data, reference time data, code phase and Doppler measurements, and beam phase measurements, among others.

Further, and based on received measurement information and information received from BS 110, LMFs 120 can generate and transmit (e.g., broadcast) assistance data to connected UEs 130. The assistance data may include, for example, reference times, reference locations, ionospheric models, earth orientation parameters, time offsets, differential corrections, Ephemeris and Clock Models, health status, data bit assistance, acquisition assistance, almanac, UTC models, and beam phase data. In some examples, a UE 130 requests assistance data from an LMF 120, and in response the LMF 120 transmits the assistance data, which includes the beam phase data, to the UE 130. As described herein, the beam phase data may identify which beams of BS 110 have a same initial phase. In some examples, an LMF 120 determines which beams of BS 110 have an initial beam phase that is within a predefined range (e.g., 5 degrees) of each other, and generates beam phase data identifying those beams as having the same initial beam phase.

In some examples, LMF 120 generates beam phase data identifying, for each of a plurality of azimuth angles as measured from BS 110, a set of beams of BS 110 that have a same initial phase. For instance, LMF 120 may determine the set of beams based on at least beam phase measurements and corresponding location measurements (e.g., latitude, longitude data) crowdsourced from UEs 130. In some examples, LMF 120 generates beam phase data that identifies, for each of a plurality of azimuth angles at each of a plurality of elevation angles, a set of beams of BS 110 that have a same initial phase. For example, LMF 120 may determine this set of beams based on at least beam phase measurements and corresponding location measurements including latitude, longitude, and elevation data, crowdsourced from UEs 130. In some examples, LMF 120 may generate the assistance data to, alternatively or additionally, identify which beams have a same drift of initial phase based on crowdsourced beam phase and reference time measurements from UEs 130. For instance, the LMF may determine, based on the crowdsourced beam phase and reference time measurements, beams that, although maintain a same phase measurement during a window of time, the same phase measurement “drifts” (e.g., increases or decreases) during the window of time.

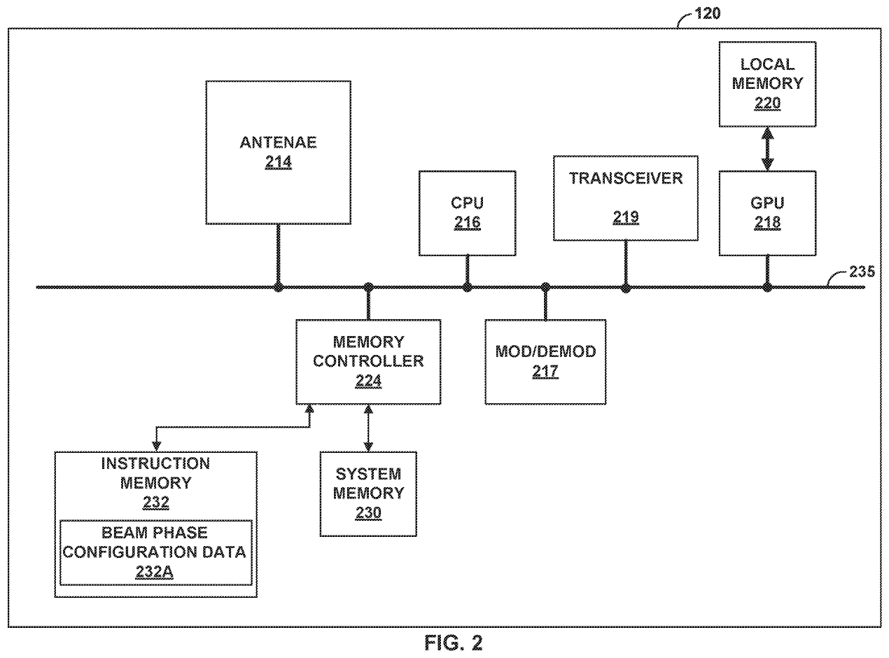

FIG. 2 illustrates a block diagram of an exemplary LMF 120. The functions of LMF 120 may be implemented in one or more processors, one or more field-programmable gate arrays (FPGAs), one or more application-specific integrated circuits (ASICs), one or more state machines, digital circuitry, any other suitable circuitry, or any suitable hardware. LMF 120 may perform one or more of the exemplary functions and processes described in this disclosure. For example, the functions of LMF 120 may be implemented across one or more servers, such as one or more cloud-based servers, or any other suitable computing devices.

As illustrated in the example of FIG. 2, LMF 120 may include an antenna 215, which may be an antenna array, a central processing unit (CPU) 216, an encoder/decoder 217, a graphics processing unit (GPU) 218, a local memory 220 of GPU 218, and a memory controller 124 that provides access to system memory 230 and to instruction memory 232.

Memory controller 224 may be communicatively coupled to system memory 230 and to instruction memory 232. Memory controller 224 may facilitate the transfer of data going into and out of system memory 230 and/or instruction memory 232. For example, memory controller 224 may receive memory read and write commands, such as from CPU 216 or GPU 218, and service such commands to provide memory services to system memory 230 and/or instruction memory 232. Although memory controller 224 is illustrated as being separate from both CPU 216 and system memory 230, in other examples, some or all of the functionality of memory controller 224 with respect to servicing system memory 230 may be implemented on one or both of CPU 216 and system memory 230. Likewise, some or all of the functionality of memory controller 224 with respect to servicing instruction memory 232 may be implemented on one or both of CPU 216 and instruction memory 232.

System memory 230 may store program modules and/or instructions and/or data that are accessible and executed by CPU 216 and/or GPU 218. For example, system memory 130 may store applications that, when executed, provide location support services to UEs as described herein. System memory 130 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), flash memory, a magnetic data media, cloud-based storage medium, or an optical storage media.

CPU 216 may store data to, and read data from, system memory 230 via memory controller 224. For example, CPU 216 may store a working set of instructions to system memory 230, such as instructions loaded from instruction memory 232. CPU 216 may also use system memory 230 to store dynamic data created during the operation of LMF 120. For example, CPU 216 may store measurement data, such as beam phase measurement data (e.g., received from UEs 130), within system memory 230. CPU 216 may also store beam phase data, and assistance data, within system memory 230. CPU 116 may comprise a general-purpose or a special-purpose processor that controls operation of LMF 120.

GPU 218 may store data to, and read data from, local memory 220. For example, GPU 218 may store a working set of instructions to local memory 220, such as instructions loaded from instruction memory 232. GPU 218 may also use local memory 220 to store dynamic data created during the operation of LMF 120. Examples of local memory 220 include one or more volatile or non-volatile memories or storage devices, such as RAM, SRAM, DRAM, EPROM, EEPROM, flash memory, a magnetic data media, a cloud-based storage medium, or an optical storage media.

In addition, LMF 120 may include a modulator and/or demodulator 217, either of which may be integrated as part of a combined modulator/demodulator. Modulator/demodulator 217 may include a modulator (e.g., Orthogonal Frequency-Division Multiplexing (OFDM) modulator) that modulates a signal for transmission (e.g., 5G transmission), and/or a demodulator that demodulates a received signal (e.g., from BS 110 or UE 130). In some instances, one or more of CPU 116 and GPU 118 may be configured to provide data to modulator/demodulator 217 for modulation, and to receive demodulated data from modulator/demodulator 217.

Instruction memory 232 may store instructions that may be accessed (e.g., read) and executed by one or more of CPU 216 and GPU 218. For example, instruction memory 232 may store instructions that, when executed by one or more of CPU 216 and GPU 218, cause one or more of CPU 216 and GPU 218 to perform one or more of the operations described herein. For instance, instruction memory 132 can include beam phase configuration data 232A that can include instructions that, when executed by one or more of CPU 216 and GPU 218, cause CPU 216 and GPU 218 to generate beam phase data identifying beams with a same initial beam phase as described herein. Further, and when executed by one or more of CPU 216 and GPU 218, the instructions can cause one or more of CPU 216 and GPU 218 to package the beam phase data within assistance data, and provide the assistance data to modulator/demodulator 217 for transmission.

Instruction memory 232 may also store instructions that, when executed by one or more of CPU 116 and GPU 118, cause one or more of camera processor CPU 116 and GPU 118 to perform any suitable LMF function, such as functions that allow for data exchanges with BS 110 and with UEs 130. Instruction memory 232 may include read-only memory (ROM) such as EEPROM, flash memory, a removable disk, CD-ROM, any non-volatile memory, any non-volatile memory, or any other suitable memory.

The various components of LMF 120, as illustrated in FIG. 2, may be configured to communicate with each other across bus 235. Bus 235 may include any of a variety of bus structures, such as a third-generation bus (e.g., a HyperTransport bus or an InfiniBand bus), a second-generation bus (e.g., an Advanced Graphics Port bus, a Peripheral Component Interconnect (PCI) Express bus, or an Advanced extensible Interface (AXI) bus), or another type of bus or device interconnect. It is to be appreciated that the specific configuration of components and communication interfaces between the different components shown in FIG. 2 is merely exemplary, and other configurations of the components, and/or other image processing systems with the same or different components, may be configured to implement the operations and processes of this disclosure.

As described herein, one or more of CPU 216 and GPU 218 may perform operations that generate assistance data that includes beam phase data identifying beams with a same initial phase. For instance, one or more of CPU 216 and GPU 218 may obtain, from system memory 230, aggregated beam phase measurement data characterizing UE 130 beam phase measurements for a plurality of beams. The one or more of CPU 216 and GPU 218 may generate beam phase data characterizing sets of the plurality of beams that include a same initial phase, and may package the beam phase data within assistance data. In some examples, the beam phase data identifies beams that have an initial beam phase that is within a predefined range of each other. In some examples, the beam phase data identifies, for each of a plurality of azimuth angles as measured from a BS (e.g., BS 110), a set of beams of the BS that have a same initial phase. In some examples, the beam phase data identifies, for each of a plurality of azimuth angles at each of a plurality of elevation angles, a set of beams of a BS that have a same initial phase. In some examples, the beam phase data, alternatively or additionally, identifies beams of a BS that have a same drift of initial phase. The one or more of CPU 216 and GPU 218 may provide the assistance data to modulator/demodulator 217 for transmission (e.g., via antenna 215) across a radio access network.

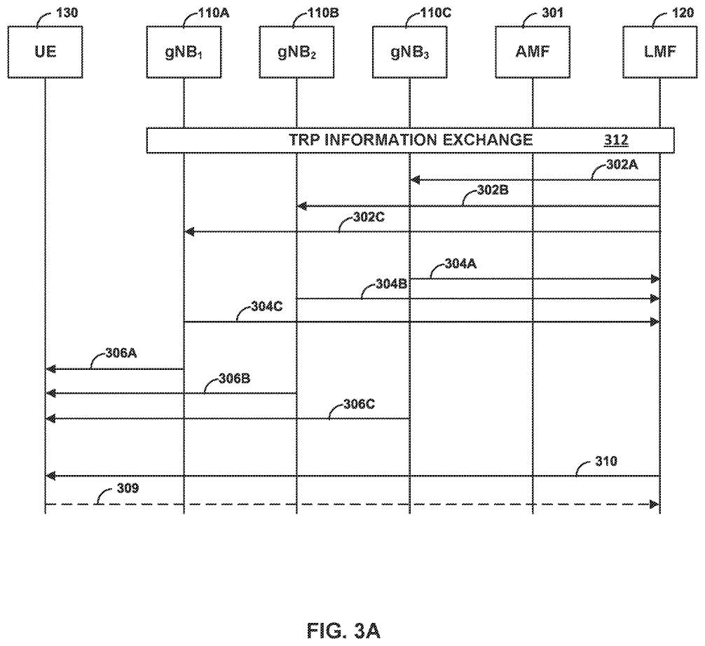

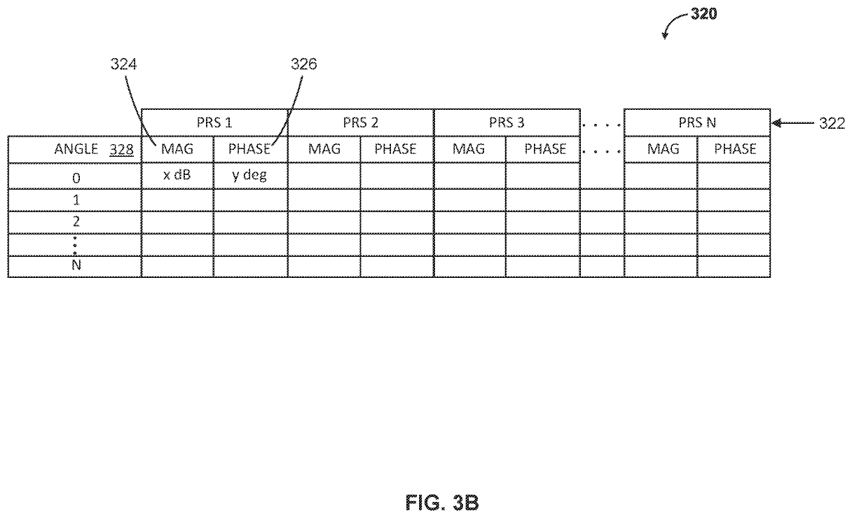

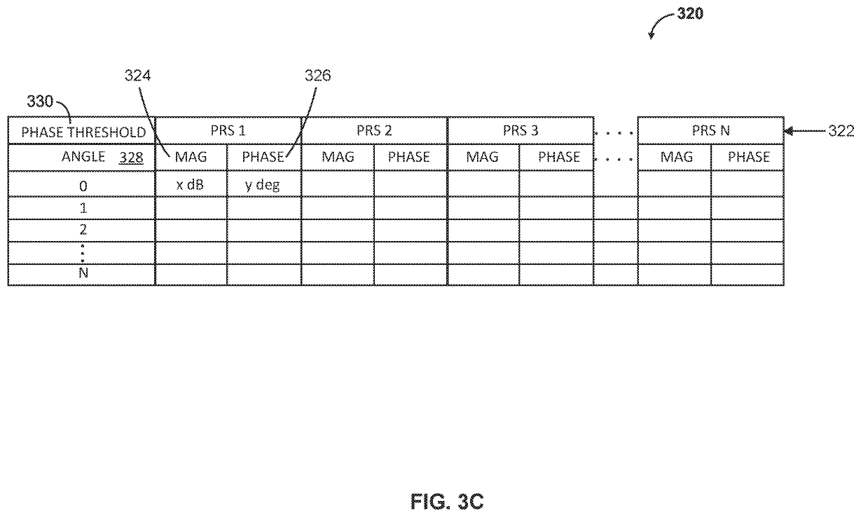

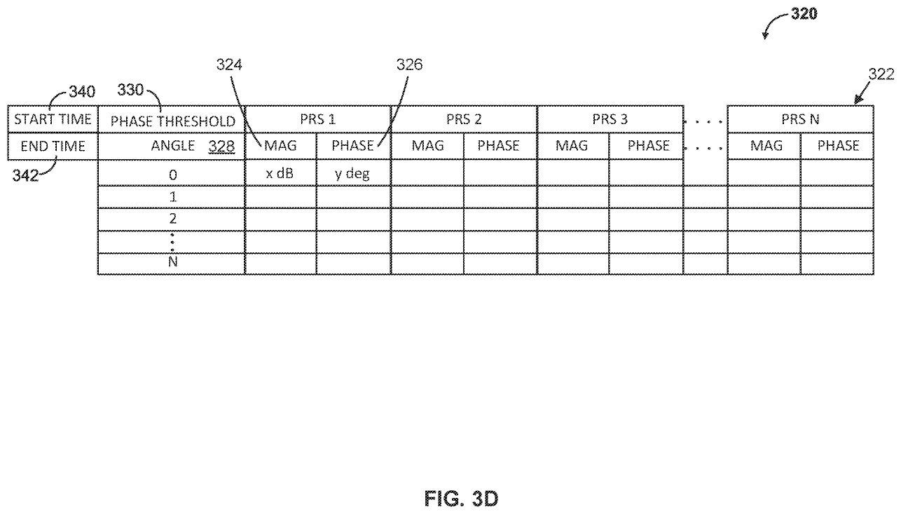

FIG. 3A illustrates exemplary messaging among a UE 130, BSs 110a (e.g., gNBs), 110b, and 110c, AMF 301, and LMF 120. Initially, transmission reception point (TRP) information 312 may be exchanged between BSs 110a, 110b, and 110c and LMF 120. As a result, for example, LMF 120 may detect and identify BSs 110a, 110b, and 110c. Further, LMF 120 may generate and transmit a DL-PRS configuration request 302a, 302b, 302c (e.g., for DL-PRS transmission characteristics and transmission off information) to each of BSs 110a, 110b, and 110c, and receive, in response, a DL-PRS configuration response 304a, 304b, and 304c characterizing a corresponding DL-PRS configuration. For example, LMF 120 may generate and transmit DL-PRS configuration request 302a to BS 110c. In response, BS 110c may generate and transmit to LMF 120 DL-PRS configuration response 304a. Similarly, LMF 120 may generate and transmit DL-PRS configuration request 302b to BS 110b and DL-PRS configuration request 302c to BS 110a, and may receive, respectively from BS 110b and BS 110a, DL-PRS configuration response 304b and DL-PRS configuration response 304c. LMF 120 may store the DL-PRS configurations for each of BSs 110a, 110b, and 110c in a data repository, such as system memory 230.

Based on the DL-PRS configurations, each of BS 110a, 110b, and 110c may begin DL-PRS transmissions (e.g., downlink transmissions) to UE 130. For example, BS 110a may begin DL-PRS transmissions 306a to UE 130. Similarly, BS 110b may begin DL-PRS transmissions 306b to UE 130, and BS 110c may begin DL-PRS transmissions 306c to UE 130.

Further, LMF 120 may generate beam phase data for each beam of each of BSs 110a, 110b, and 110c, where the beam data identifies beams of a same initial phase for each of BSs 110a, 110b, and 110c. For example, and based on beam phase measurements received from BSs 110a, 110b, and 110c and/or UEs such as UE 130, LMF 120 may determine beams with a same initial phase for each of BSs 110a, 110b, and 110c. LMF 120 may generate beam phase data identifying the beams with the same initial phase, and may package the beam phase data within assistance data 310. LMF 120 may transmit the assistance data 310 to any connected UEs, such as UE 130. For instance, LMF 120 may broadcast the assistance data 310 (e.g., as a broadcast message), and any connected UEs may receive the assistance data 310. In some examples, UE 130 transmits an assistance data request 309 to LMF 120, and in response, LMF 120 transmits the assistance data 310 to UE 130.

FIGS. 3B, 3C, and 3D illustrate exemplary beam phase data, such as beam phase data 320, that may be packaged within assistance data for transmission. As described herein, the beam phase data 320 may indicate initial beam phase angles of beams to be expected by a UE within a particular geographical region. For example, and with reference to FIG. 3B, in some examples the beam phase data 320 may identify, for each of a plurality of PRS signals 322 at each of a plurality of angles 328 (e.g., azimuth angles) with respect to the corresponding PRS signal 322, a magnitude 324 (e.g., in dB) and a beam phase 326. The magnitude 324 may correspond to a magnitude of the signal that the UE 130 should expect or detect at the UE's 130 current location, while the phase 326 indicates PRS signals 322 with a same beam phase. For instance, the beam phase data 320 may have a same phase 326 value for PRS signals 322 with a same beam phase. In some examples, each magnitude 324 and corresponding phase 326 include a total number of bits (e.g., 8). PRS signals 322 with a same value as identified by the phase 326 bits indicate PRS signals with a same beam phase. For instance, PRS signals 322 with a phase 326 bits value of 0x01 may indicate a first set of PRS signals with a same initial phase. PRS signals 322 with a phase 326 bits value of 0x02 may indicate a second set of PRS signals with a same initial phase, and so on. In some examples, the value indicated by the phase 326 bits corresponds to a phase angle. For instance, a phase 326 bits value of 0x0A may indicate an initial beam phase of ten degrees, while a phase 326 bits value of 0x0F may indicate an initial beam phase of 16 degrees.

In some examples, as described herein, the LMF 120 may determine that initial beam phase measurements that fall within a beam phase range are similar, and thus may identify the corresponding beams as having a same initial phase. In some of these examples, the LMF 120 may generate the beam phase data 320 to include the beam phase range. For example, FIG. 3B illustrates beam phase data 320 that includes a phase threshold 330 identifying a beam phase range. For each of the plurality of angles 328, PRS signals 322 with the same phase 326 bits value identify beams with similar initial beam phases that are within the beam phase range identified by the phase threshold 330.

In some examples, the LMF 120 may generate beam phase data 320 that identifies a window of time during which beams have a same initial beam phase. For example, the LMF 120 may obtain, in addition to beam phase measurements, reference time data indicating a time that the beam phase measurements were determined by UEs. LMF 120 may determine a time window based on the times that the beam phase measurements were determined by the UEs. For instance, LMF 120 may determine an earliest time, and a latest time, of the times during which the beam phase measurements are within a range (e.g., within 10 μm, the same) across beams, and may generate time window data indicating that the beams have the same beam phase starting with the earliest time and ending with the latest time.

For example, FIG. 3C illustrates beam phase data 320 that includes a start time 340 identifying a start time of the window; and an end time 342 of the window. For each of the plurality of angles 328, PRS signals 322 with the same phase 326 bits value identify beams with similar initial beam phases during the window defined by start time 340 and end time 342, and that are within the beam phase range identified by the phase threshold 330.

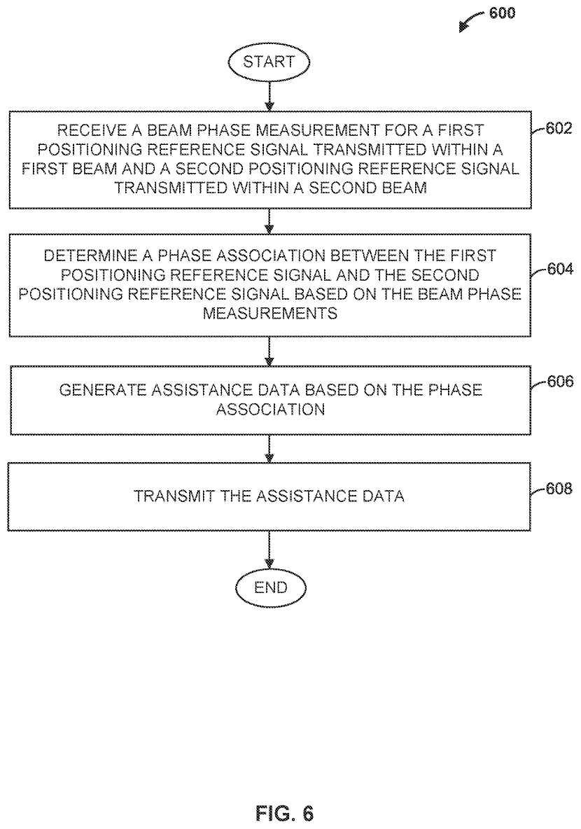

FIG. 6 is a flowchart of an example process 600 for generating assistance data that identifies beams with same initial beam phases. In some instances, one or more processors executing instructions locally at a computing device, such as by one or more of CPU 116 and GPU 118 of LMF 120 of FIGS. 1 and 2, may perform one or more operations of exemplary process 600. Accordingly, the various operations of process 600 may be represented by executable instructions held in storage media of one or more computing platforms, such as instruction memory 232 of LMF 120.

At block 602, a beam phase measurement for a first positioning reference signal (PRS) transmitted within a first beam is received. Additionally, a beam phase measurement for a second PRS transmitted within a second beam is also received. For instance, LMF 120 may receive, from BS 110, beam phase measurements captured by one or more UEs 130. At block 604, a phase association between the first PRS and the second PRS is determined based on the beam phase measurements. As an example, LMF 120 may determine, for a particular geographical area, beams with initial beam phase measurements that are the same. The geographical area may correspond to a location of the UEs 130 where the beam phase measurements were made. In some examples, LMF 120 determines that beam phase measurements within a beam phase range of each other are the same, as described herein. In yet other examples, LMF 120 determines beam phase measurements that are the same for a geographical area during a time window, such as between a start time and an end time, as described herein.

Proceeding to step 606, assistance data is generated based on the phase association. For instance, LMF 120 may generate beam phase data characterizing the phase association, and package the beam phase data within assistance data 310. At step 608, the association data is transmitted across a radio access network. For instance, LMF 120 may broadcast the assistance data 310. In some examples, LMF 120 may transmit the assistance data 310 to a UE in response to an assistance data request 309.

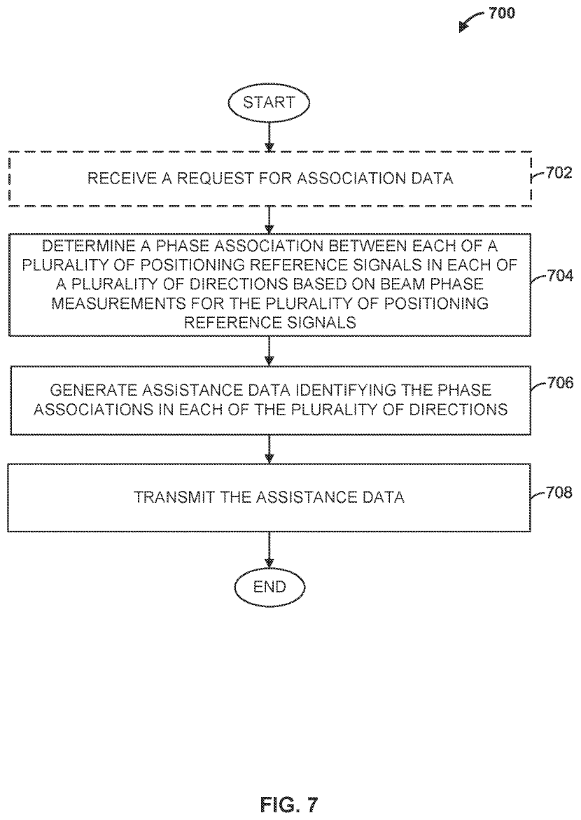

FIG. 7 is a flowchart of an example process 700 for generating assistance data that identifies beams with same initial beam phases. In some instances, one or more processors executing instructions locally at a computing device, such as by one or more of CPU 116 and GPU 118 of LMF 120 of FIGS. 1 and 2, may perform one or more of the operations of exemplary process 700. Accordingly, the various operations of process 600 may be represented by executable instructions held in storage media of one or more computing platforms, such as instruction memory 232 of LMF 120.

In this example, at step 702, which is optional, a request for association data is received. For example, LMF 120 may receive an assistance data request 309 from a UE. At step 704, a phase association between each of a plurality of positioning reference signals is determined in each of a plurality of directions. The phase associations may be determined based on beam phase measurements for the plurality of positioning reference signals that are transmitted in the plurality of directions.

For example, LMF 120 may receive crowdsourced beam phase measurements that were obtained for beams of BS 110 that are transmitted in each of a plurality of directions, such as the eight beams 550 transmitted in various directions by TRP 502 illustrated in FIG. 5B. BS 110 may transmit the beam phase measurements to LMF 120. In some examples, the BS 110 may store the beam phase measurements in a data repository, and LMF 120 may obtain the beam phase measurements from the data repository. Further, LMF 120 may determine beams with initial beam phase measurements that are the same in each of the plurality of directions. For instance, LMF 120 may determine a subset of beams 550 that, when transmitting at a particular azimuth angle with respect to BS 110, have a same initial beam phase. In some examples, beam phase measurements may indicate that two or more beams have the same initial beam phase in one direction (e.g., azimuth angle of 10 degrees), but have varying beam phase measurements in another direction (e.g., azimuth angle of 90 degrees).

In some examples, LMF 120 determines that beam phase measurements within a beam phase range of each other, such as within 5 degrees of each other, are the same. LMF 120 may make those determinations in each of the plurality of directions, as described herein. In yet other examples, LMF 120 determines beam phase measurements that are the same in each of the plurality of directions during a time window, such as between a start time and an end time, as described herein.

Proceeding to step 706, assistance data is generated identifying the phase associations in each of the plurality of directions. For instance, LMF 120 may generate beam phase data characterizing phase associations in each of the plurality of directions, such as beam phase data 320 identifying a beam phase 326 for each of a plurality of PRS signals 322 at each of a plurality of angles 328. At step 708, the association data is transmitted across a radio access network. For instance, LMF 120 may broadcast the assistance data 310. In some examples, LMF 120 may transmit the assistance data 310 to the UE in response to receiving the assistance data request 309 in step 702.

Implementation examples are further described in the following numbered clauses:
1. An apparatus comprising:
a non-transitory, machine-readable storage medium storing instructions; and
at least one processor coupled to the non-transitory, machine-readable storage medium, the at least one processor being configured to:
   obtain a first phase value for a first beam;
   obtain a second phase value for a second beam;
   generate phase association data characterizing a phase association between the first beam and the second beam based on the first phase value and the second phase value; and
   transmit assistance data comprising the phase association data across a radio access network.
2. The apparatus of clause 1, wherein the at least one processor is further configured to execute the instructions to determine that the first phase value is equivalent to the second phase value.
3. The apparatus of any of clauses 1-2, wherein the at least one processor is further configured to execute the instructions to determine that the first phase value is disposed within a range of the second phase value.
4. The apparatus of clause 3, wherein the at least one processor is further configured to execute the instructions to determine that the first phase value is disposed within the range of the second phase value when a difference between the first phase value and the second phase value is less than a threshold.
5. The apparatus of any of clauses 1-4, wherein the at least one processor is further configured to execute the instructions to:
receive a first phase measurement for a first positioning reference signal transmitted using the first beam;
receive a second phase measurement for a second positioning reference signal transmitted using the second beam;
determine the first phase value based on the first phase measurement; and
determine the second phase value based on the second phase measurement.
6. The apparatus of clause 5, wherein the at least one processor is further configured to execute the instructions to:
receive a plurality of first phase measurements associated with the first positioning reference signal, the plurality of first phase measurements comprising the first phase measurement;
receive a plurality of second phase measurements associated with the second positioning reference signal, the plurality of second phase measurements comprising the second phase measurement;
receive first temporal data identifying first capture times associated with the plurality of first phase measurements;
receive second temporal data identifying second capture times associated with the plurality of second phase measurements;
determine a drift of the first beam with respect to the second beam based on the plurality of first phase measurements, the plurality of second phase measurements, the first temporal data, and the second temporal data; and
generate the assistance data, the assistance data characterizing the drift.
7. The apparatus of any of clauses 1-6, wherein the at least one processor is further configured to execute the instructions to:
receive first and second temporal data, the first temporal data identifying a first capture time associated with the first phase value, and the second temporal data identifying a second capture time associated with the second phase value;
determine that the first capture time is disposed within a range of the second capture time;
generate temporal window data based on the determination that the first capture time is disposed within the range of the second capture time; and
determine the phase association based on the time window data.
8. The apparatus of any of clauses 1-7, wherein the at least one processor is further configured to execute the instructions to:
receive first and second location data, the first location data identifying a first capture location associated with the first phase value, and the second location data identifying a second capture location associated with the second phase value; and
determine the phase association based on a determination that the first capture location is within a same geographical area as the second capture location.
9. The apparatus of clause 8, wherein the first location data and the second location data comprise a value of a latitude, a longitude, or an elevation.
10. The apparatus of any of clauses 1-9, wherein the first beam and the second beam are line of site (LOS) beams with respect to a geographical area.
11. The apparatus of any of clauses 1-10, wherein the first beam and the second beam are transmitted by a base station, and wherein the at least one processor is further configured to execute the instructions to:
receive first and second location data, the first location data identifying a first capture location associated with the first phase value, and the second location data identifying a second capture location associated with the second phase value;
generate angle data characterizing a first angle of the first capture location with respect to the base station and a second angle of the second capture location with respect to the base station; and
generate the assistance data, the assistance data comprising the angle data.
12. The apparatus of any of clauses 1-11, wherein the at least one processor is further configured to execute the instructions to:
receive a request from a user equipment for the assistance data; and
transmit the assistance data to the user equipment in response to the request.
13. The apparatus of any of clauses 1-12, wherein the at least one processor is further configured to execute the instructions to generate the assistance data to include drift data characterizing a drift between the first beam and the second beam.
14. A method comprising:
obtaining a first phase value for a first beam;
obtaining a second phase value for a second beam;
generating phase association data characterizing a phase association between the first beam and the second beam based on the first phase value and the second phase value; and
transmitting assistance data comprising the phase association data across a radio access network.
15. The method of clause 14, comprising determining that the first phase value is equivalent to the second phase value.
16. The method of any of clauses 14-15, comprising determining that the first phase value is disposed within a range of the second phase value.
17. The method of clause 16, comprising determining that the first phase value is disposed within the range of the second phase value when a difference between the first phase value and the second phase value is less than a threshold.
18. The method of any of clauses 14-17, comprising:
receiving a first phase measurement for a first positioning reference signal transmitted using the first beam;
receiving a second phase measurement for a second positioning reference signal transmitted using the second beam;
determining the first phase value based on the first phase measurement; and
determining the second phase value based on the second phase measurement.
19. The method of clause 18, comprising:
receiving a plurality of first phase measurements associated with the first positioning reference signal, the plurality of first phase measurements comprising the first phase measurement;
receiving a plurality of second phase measurements associated with the second positioning reference signal, the plurality of second phase measurements comprising the second phase measurement;
receiving first temporal data identifying first capture times associated with the plurality of first phase measurements;
receiving second temporal data identifying second capture times associated with the plurality of second phase measurements;
determining a drift of the first beam with respect to the second beam based on the plurality of first phase measurements, the plurality of second phase measurements, the first temporal data, and the second temporal data; and
generating the assistance data, the assistance data characterizing the drift.
20. The method of any of clauses 14-19, comprising:
receiving first and second temporal data, the first temporal data identifying a first capture time associated with the first phase value, and the second temporal data identifying a second capture time associated with the second phase value;
determining that the first capture time is disposed within a range of the second capture time;
generating temporal window data based on the determination that the first capture time is disposed within the range of the second capture time; and
determining the phase association based on the time window data.
21. The method of any of clauses 14-20, comprising:
receiving first and second location data, the first location data identifying a first capture location associated with the first phase value, and the second location data identifying a second capture location associated with the second phase value; and
determining the phase association based on a determination that the first capture location is within a same geographical area as the second capture location.
22. The method of clause 21, wherein the first location data and the second location data comprise a value of a latitude, a longitude, or an elevation.
23. The method of any of clauses 14-22, wherein the first beam and the second beam are line of site (LOS) beams with respect to a geographical area.
24. The method of any of clauses 14-23, wherein the first beam and the second beam are transmitted by a base station, and wherein the method comprises:
receiving first and second location data, the first location data identifying a first capture location associated with the first phase value, and the second location data identifying a second capture location associated with the second phase value;
generating angle data characterizing a first angle of the first capture location with respect to the base station and a second angle of the second capture location with respect to the base station; and
generating the assistance data, the assistance data comprising the angle data.
25. The method of any of clauses 14-24, comprising:
receiving a request from a user equipment for the assistance data; and
transmitting the assistance data to the user equipment in response to the request.
26. The method of any of clauses 14-25, comprising generating the assistance data to include drift data characterizing a drift between the first beam and the second beam.
27. A non-transitory, machine-readable storage medium storing instructions that, when executed by at least one processor, causes the at least one processor to perform operations that include:
obtaining a first phase value for a first beam;
obtaining a second phase value for a second beam;
generating phase association data characterizing a phase association between the first beam and the second beam based on the first phase value and the second phase value; and
transmitting assistance data comprising the phase association data across a radio access network.
28. The non-transitory, machine-readable storage medium of clause 27, wherein the instructions, when executed by the at least one processor, causes the at least one processor to perform addition operations comprising determining that the first phase value is equivalent to the second phase value.
29. The non-transitory, machine-readable storage medium of any of clauses 27-28, wherein the instructions, when executed by the at least one processor, causes the at least one processor to perform addition operations comprising determining that the first phase value is disposed within a range of the second phase value.
30. The non-transitory, machine-readable storage medium of clause 29, wherein the instructions, when executed by the at least one processor, causes the at least one processor to perform addition operations comprising determining that the first phase value is disposed within the range of the second phase value when a difference between the first phase value and the second phase value is less than a threshold.
31. The non-transitory, machine-readable storage medium of any of clauses 27-30, wherein the instructions, when executed by the at least one processor, causes the at least one processor to perform addition operations comprising:
receiving a first phase measurement for a first positioning reference signal transmitted using the first beam;
receiving a second phase measurement for a second positioning reference signal transmitted using the second beam;
determining the first phase value based on the first phase measurement; and
determining the second phase value based on the second phase measurement.
32. The non-transitory, machine-readable storage medium of clause 31, wherein the instructions, when executed by the at least one processor, causes the at least one processor to perform addition operations comprising:
receiving a plurality of first phase measurements associated with the first positioning reference signal, the plurality of first phase measurements comprising the first phase measurement;
receiving a plurality of second phase measurements associated with the second positioning reference signal, the plurality of second phase measurements comprising the second phase measurement;
receiving first temporal data identifying first capture times associated with the plurality of first phase measurements;
receiving second temporal data identifying second capture times associated with the plurality of second phase measurements;
determining a drift of the first beam with respect to the second beam based on the plurality of first phase measurements, the plurality of second phase measurements, the first temporal data, and the second temporal data; and
generating the assistance data, the assistance data characterizing the drift.
33. The non-transitory, machine-readable storage medium of any of clauses 27-32, wherein the instructions, when executed by the at least one processor, causes the at least one processor to perform addition operations comprising:
receiving first and second temporal data, the first temporal data identifying a first capture time associated with the first phase value, and the second temporal data identifying a second capture time associated with the second phase value;
determining that the first capture time is disposed within a range of the second capture time;
generating temporal window data based on the determination that the first capture time is disposed within the range of the second capture time; and
determining the phase association based on the time window data.
34. The non-transitory, machine-readable storage medium of any of clauses 27-33, wherein the instructions, when executed by the at least one processor, causes the at least one processor to perform addition operations comprising:
receiving first and second location data, the first location data identifying a first capture location associated with the first phase value, and the second location data identifying a second capture location associated with the second phase value; and
determining the phase association based on a determination that the first capture location is within a same geographical area as the second capture location.
35. The non-transitory, machine-readable storage medium of clause 34, wherein the first location data and the second location data comprise a value of a latitude, a longitude, or an elevation.
36. The non-transitory, machine-readable storage medium of any of clauses 27-35, wherein the first beam and the second beam are line of site (LOS) beams with respect to a geographical area.
37. The non-transitory, machine-readable storage medium of any of clauses 27-36, wherein the first beam and the second beam are transmitted by a base station, and wherein the instructions, when executed by the at least one processor, causes the at least one processor to perform addition operations comprising:
receiving first and second location data, the first location data identifying a first capture location associated with the first phase value, and the second location data identifying a second capture location associated with the second phase value;
generating angle data characterizing a first angle of the first capture location with respect to the base station and a second angle of the second capture location with respect to the base station; and
generating the assistance data, the assistance data comprising the angle data.
38. The non-transitory, machine-readable storage medium of any of clauses 27-37, wherein the instructions, when executed by the at least one processor, causes the at least one processor to perform addition operations comprising:
receiving a request from a user equipment for the assistance data; and
transmitting the assistance data to the user equipment in response to the request.
39. The non-transitory, machine-readable storage medium of any of clauses 27-38, wherein the instructions, when executed by the at least one processor, causes the at least one processor to perform addition operations comprising generating the assistance data to include drift data characterizing a drift between the first beam and the second beam.
40. An apparatus comprising:
a means for obtaining a first phase value for a first beam;
a means for obtaining a second phase value for a second beam;
a means for generating phase association data characterizing a phase association between the first beam and the second beam based on the first phase value and the second phase value; and
a means for transmitting assistance data comprising the phase association data across a radio access network.
41. The apparatus of clause 40, comprising a means for determining that the first phase value is equivalent to the second phase value.
42. The apparatus of any of clauses 40-41, comprising a means for determining that the first phase value is disposed within a range of the second phase value.
43. The apparatus of clause 42, comprising a means for determining that the first phase value is disposed within the range of the second phase value when a difference between the first phase value and the second phase value is less than a threshold.
44. The apparatus of any of clauses 40-43, comprising:
a means for receiving a first phase measurement for a first positioning reference signal transmitted using the first beam;
a means for receiving a second phase measurement for a second positioning reference signal transmitted using the second beam;
a means for determining the first phase value based on the first phase measurement; and
a means for determining the second phase value based on the second phase measurement.
45. The apparatus of clause 44, comprising:
a means for receiving a plurality of first phase measurements associated with the first positioning reference signal, the plurality of first phase measurements comprising the first phase measurement;
a means for receiving a plurality of second phase measurements associated with the second positioning reference signal, the plurality of second phase measurements comprising the second phase measurement;
a means for receiving first temporal data identifying first capture times associated with the plurality of first phase measurements;
a means for receiving second temporal data identifying second capture times associated with the plurality of second phase measurements;
a means for determining a drift of the first beam with respect to the second beam based on the plurality of first phase measurements, the plurality of second phase measurements, the first temporal data, and the second temporal data; and
a means for generating the assistance data, the assistance data characterizing the drift.
46. The apparatus of any of clauses 40-45, comprising:
a means for receiving first and second temporal data, the first temporal data identifying a first capture time associated with the first phase value, and the second temporal data identifying a second capture time associated with the second phase value;
a means for determining that the first capture time is disposed within a range of the second capture time;
a means for generating temporal window data based on the determination that the first capture time is disposed within the range of the second capture time; and
a means for determining the phase association based on the time window data.
47. The apparatus of any of clauses 40-46, comprising:
a means for receiving first and second location data, the first location data identifying a first capture location associated with the first phase value, and the second location data identifying a second capture location associated with the second phase value; and
a means for determining the phase association based on a determination that the first capture location is within a same geographical area as the second capture location.
48. The apparatus of clause 47, wherein the first location data and the second location data comprise a value of a latitude, a longitude, or an elevation.
49. The apparatus of any of clauses 40-48, wherein the first beam and the second beam are line of site (LOS) beams with respect to a geographical area.
50. The apparatus of any of clauses 40-49, wherein the first beam and the second beam are transmitted by a base station, and wherein the method comprises:
a means for receiving first and second location data, the first location data identifying a first capture location associated with the first phase value, and the second location data identifying a second capture location associated with the second phase value;
a means for generating angle data characterizing a first angle of the first capture location with respect to the base station and a second angle of the second capture location with respect to the base station; and
a means for generating the assistance data, the assistance data comprising the angle data.
51. The apparatus of any of clauses 40-50, comprising:
a means for receiving a request from a user equipment for the assistance data; and
a means for transmitting the assistance data to the user equipment in response to the request.
52. The apparatus of any of clauses 40-51, comprising a means for generating the assistance data to include drift data characterizing a drift between the first beam and the second beam.

Although the methods described above are with reference to the illustrated flowcharts, many other ways of performing the acts associated with the methods may be used. For example, the order of some operations may be changed, and some embodiments may omit one or more of the operations described and/or include additional operations.

Additionally, the methods and system described herein may be at least partially embodied in the form of computer-implemented processes and apparatus for practicing those processes. The disclosed methods may also be at least partially embodied in the form of tangible, non-transitory machine-readable storage media encoded with computer program code. For example, the methods may be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, computer program code segments configure the processor to create specific logic circuits. The methods may alternatively be at least partially embodied in application specific integrated circuits for performing the methods.

We claim:

1. An apparatus comprising:
a non-transitory, machine-readable storage medium storing instructions; and
at least one processor coupled to the non-transitory, machine-readable storage medium, the at least one processor being configured to execute the instructions to:
obtain a first phase value for a first beam;
obtain a second phase value for a second beam;
generate phase association data characterizing a phase association between the first beam and the second beam based on the first phase value and the second phase value; and
transmit assistance data comprising the phase association data across a radio access network.

2. The apparatus of claim 1, wherein the at least one processor is further configured to execute the instructions to determine that the first phase value is equivalent to the second phase value.

3. The apparatus of claim 1, wherein the at least one processor is further configured to execute the instructions to determine that the first phase value is disposed within a range of the second phase value.

4. The apparatus of claim 3, wherein the at least one processor is further configured to execute the instructions to determine that the first phase value is disposed within the range of the second phase value when a difference between the first phase value and the second phase value is less than a threshold.

5. The apparatus of claim 1, wherein the at least one processor is further configured to execute the instructions to:
receive a first phase measurement for a first positioning reference signal transmitted using the first beam;
receive a second phase measurement for a second positioning reference signal transmitted using the second beam;
determine the first phase value based on the first phase measurement; and
determine the second phase value based on the second phase measurement.

6. The apparatus of claim 5, wherein the at least one processor is further configured to execute the instructions to:
receive a plurality of first phase measurements associated with the first positioning reference signal, the plurality of first phase measurements comprising the first phase measurement;
receive a plurality of second phase measurements associated with the second positioning reference signal, the plurality of second phase measurements comprising the second phase measurement;
receive first temporal data identifying first capture times associated with the plurality of first phase measurements;
receive second temporal data identifying second capture times associated with the plurality of second phase measurements;
determine a drift of the first beam with respect to the second beam based on the plurality of first phase measurements, the plurality of second phase measurements, the first temporal data, and the second temporal data; and
generate the assistance data, the assistance data characterizing the drift.

7. The apparatus of claim 1, wherein the at least one processor is further configured to execute the instructions to:
receive first and second temporal data, the first temporal data identifying a first capture time associated with the first phase value, and the second temporal data identifying a second capture time associated with the second phase value;
determine that the first capture time is disposed within a range of the second capture time;
generate temporal window data based on the determination that the first capture time is disposed within the range of the second capture time; and
determine the phase association based on the time window data.

8. The apparatus of claim 1, wherein the at least one processor is further configured to execute the instructions to:
receive first and second location data, the first location data identifying a first capture location associated with the first phase value, and the second location data identifying a second capture location associated with the second phase value; and
determine the phase association based on a determination that the first capture location is within a same geographical area as the second capture location.

9. The apparatus of claim 8, wherein the first location data and the second location data comprise a value of a latitude, a longitude, or an elevation.

10. The apparatus of claim 1, wherein the first beam and the second beam are line of site (LOS) beams with respect to a geographical area.

11. The apparatus of claim 1, wherein the first beam and the second beam are transmitted by a base station, and wherein the at least one processor is further configured to execute the instructions to:
receive first and second location data, the first location data identifying a first capture location associated with the first phase value, and the second location data identifying a second capture location associated with the second phase value;
generate angle data characterizing a first angle of the first capture location with respect to the base station and a second angle of the second capture location with respect to the base station; and
generate the assistance data, the assistance data comprising the angle data.

12. The apparatus of claim 1, wherein the at least one processor is further configured to execute the instructions to:
receive a request from a user equipment for the assistance data; and
transmit the assistance data to the user equipment in response to the request.

13. The apparatus of claim 1, wherein the at least one processor is further configured to execute the instructions to generate the assistance data to include drift data characterizing a drift between the first beam and the second beam.

14. A method comprising:
obtaining a first phase value for a first beam;
obtaining a second phase value for a second beam;
generating phase association data characterizing a phase association between the first beam and the second beam based on the first phase value and the second phase value; and
transmitting assistance data comprising the phase association data across a radio access network.

15. The method of claim 14, comprising determining that the first phase value is equivalent to the second phase value.

16. The method of claim 15, comprising determining that the first phase value is disposed within the range of the second phase value when a difference between the first phase value and the second phase value is less than a threshold.

17. The method of claim 14, comprising:
receiving a first phase measurement for a first positioning reference signal transmitted using the first beam;
receiving a second phase measurement for a second positioning reference signal transmitted using the second beam;
determining the first phase value based on the first phase measurement; and
determining the second phase value based on the second phase measurement.

18. The method of claim 17, comprising:
receiving a plurality of first phase measurements associated with the first positioning reference signal, the plurality of first phase measurements comprising the first phase measurement;
receiving a plurality of second phase measurements associated with the second positioning reference signal, the plurality of second phase measurements comprising the second phase measurement;
receiving first temporal data identifying first capture times associated with the plurality of first phase measurements;
receiving second temporal data identifying second capture times associated with the plurality of second phase measurements;
determining a drift of the first beam with respect to the second beam based on the plurality of first phase measurements, the plurality of second phase measurements, the first temporal data, and the second temporal data; and
generating the assistance data, the assistance data characterizing the drift.

19. The method of claim 14, comprising:
receiving first and second location data, the first location data identifying a first capture location associated with the first phase value, and the second location data identifying a second capture location associated with the second phase value; and
determining the phase association based on a determination that the first capture location is within a same geographical area as the second capture location.

20. A non-transitory, machine-readable storage medium storing instructions that, when executed by at least one processor, causes the at least one processor to perform operations that include:
obtaining a first phase value for a first beam;
obtaining a second phase value for a second beam;
generating phase association data characterizing a phase association between the first beam and the second beam based on the first phase value and the second phase value; and
transmitting assistance data comprising the phase association data across a radio access network.
